(19) United States
(12) Patent Application Publication
(10) Pub. No.: US 2013/0178099 A1
(43) Pub. Date: Jul. 11, 2013

(54) HIGH-DENSITY DUAL-SOCKET CONNECTOR

(71) Applicants: XIANG HUANG, Shenzhen City (CN); Chunyuan Tang, Shenzhen City (CN)

(72) Inventors: XIANG HUANG, Shenzhen City (CN); Chunyuan Tang, Shenzhen City (CN)

(21) Appl. No.: 13/346,736

(22) Filed: Jan. 10, 2012

(51) Int. Cl. H01R 13/514; H01R 13/648

(52) U.S. Cl. 439/607.01; 439/701

(57) ABSTRACT

The high-density connector contains an insulating body having at least two socket pieces extended towards a front direction. Each socket piece contains an accommodation space and, along a top side and a bottom side of the accommodation space, there is an array of terminals, respectively. A first terminal hole is configured on the body connecting the accommodation space. A terminal positioning seat with a second terminal hole is configured on the back side of the body. For each terminal, one of its ends penetrates the first terminal hole into the accommodation space and the other end penetrates the second terminal hole into the terminal positioning seat. The high-density connector with two sockets is capable of connecting two cables so as to achieve reduced space footprint and cost.

### (a) TECHNICAL FIELD OF THE INVENTION

The present invention is generally related to connectors, and more particular to high-density connectors.

### (b) DESCRIPTION OF THE PRIOR ART

As computing technology advances, more and more computers are required to have a small form factor. Inside computers, circuit boards are as such stacked or layered so as to fit the reduced space. Similarly, connectors are facing the same challenge and high-density connectors are therefore developed. Conventional high-density connectors provide a single connection interface. To connect multiple cables, then multiple connectors are required, which not only takes up more space but also costs more.

### SUMMARY OF THE INVENTION

A major objective of the present invention is provide a high-density connector with two sockets capable of connecting two cables so as to achieve reduced space footprint and cost. To achieve the objective, the high-density connector contains an insulating body having at least two socket pieces extended towards a front direction. Each socket piece contains an accommodation space and, along a top side and a bottom side of the accommodation space, there is an array of terminals slots, respectively. A first terminal hole is configured on the body connecting the accommodation space. A terminal positioning seat with a second terminal hole is configured on the back side of the body. For each terminal, one of its ends penetrates the first terminal hole into the accommodation space and the other end penetrates the second terminal hole into the terminal positioning seat.

The connector provides two sockets and therefore it is capable of connecting two cables with a single connector, instead of two connectors. The space required is reduced and the cost is lowered. Terminals are securely positioned in the accommodation space to enhance connection reliability. The terminal positioning seat on the other hand facilitates the configuration of the terminals and helps positioning the terminals.

Alternatively, along two lateral sides of the terminal positioning seat, a fringe is configured, respectively, so as to be received by a corresponding slot on the body. This not only facilitates the assembly of the terminal positioning seat but also prevents the terminal positioning seat from misalignment.

Alternatively, a front side of the terminal positioning seat is configured to have a step-wise shape so that the terminals are spaced apart to prevent short circuit and to enhance signal transmission reliability.

Alternatively, at least a bolt holes is configured on the body so as to enhance the connector's connection with the cables.

Alternatively, the body and socket pieces are housed in a metallic casing for protection and shielding.

Each terminal contains a contact section, an installation section, a corner section, and a soldering section. The contact section penetrates into the accommodation space. The soldering section penetrates into the terminal positioning seat. Upon the installation sections of the terminals, a terminal installation seat is positioned.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective break-down diagram showing the various components of a high-density connector according an embodiment of the present invention.

FIG. 2 is a perspective diagram showing the connector of FIG. 1 after its assembly.

FIG. 3 is a perspective diagram showing a body and two socket pieces of the connector of FIG. 1.

FIG. 4 is a perspective diagram showing a body and a terminal positioning seat of the connector of FIG. 1.

FIG. 5 is a perspective diagram showing a terminal of the connector of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

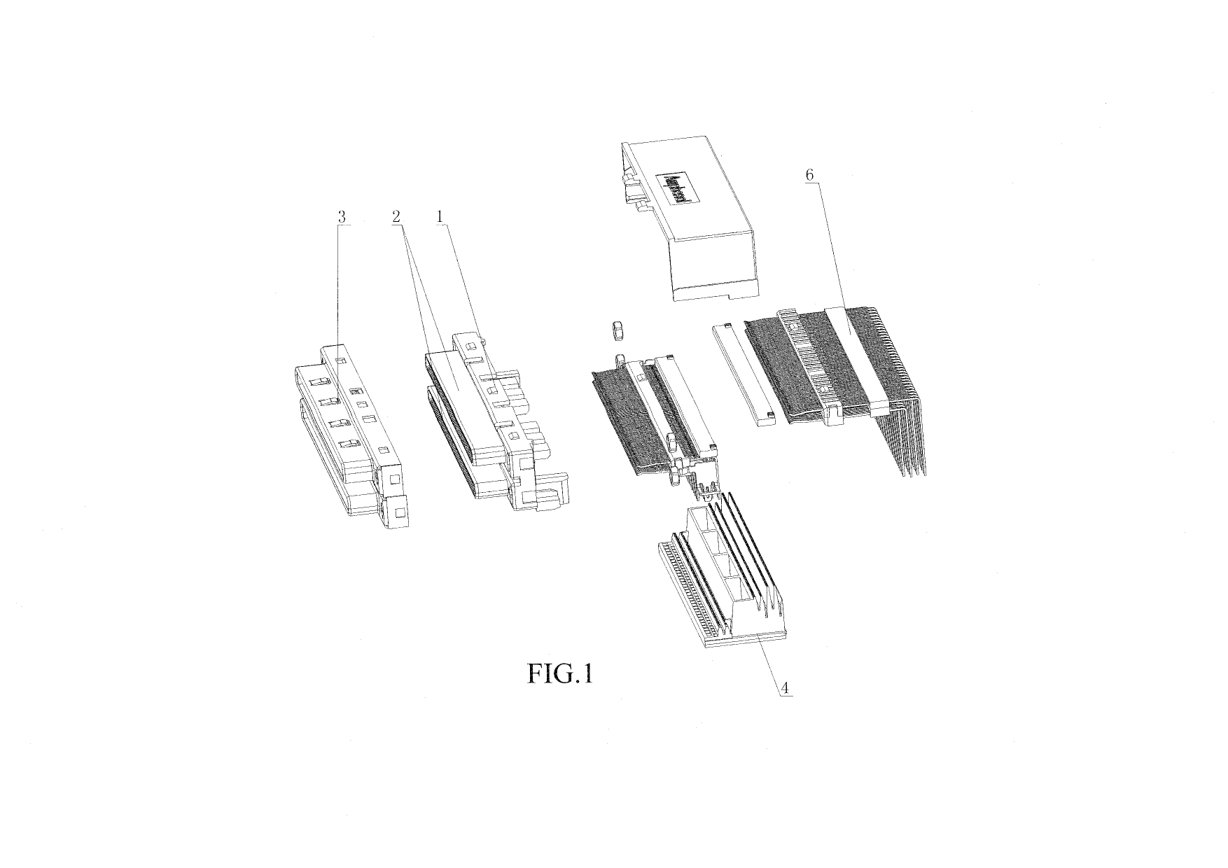

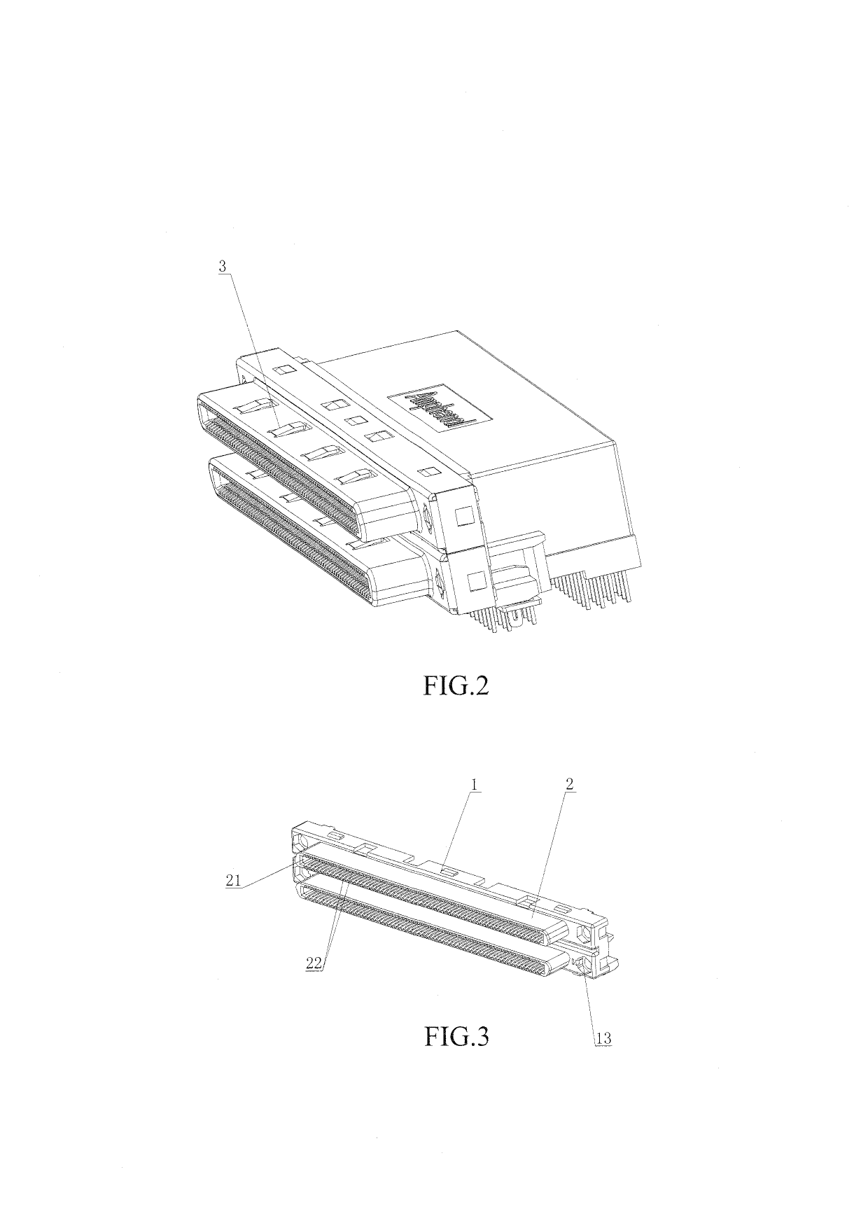

As shown in FIGS. 1 and 2, a high-density connector according to an embodiment of the present invention contains an insulating body 1 having two socket pieces 2 extended in parallel from the body 1 towards a front direction. As further shown in FIG. 3, each socket piece 2 contains an accommodation space 21 open to the front direction. Along a top side and a bottom side of the accommodation space 21, there is an array of terminal slots 22, respectively. Along a back side of the body 1, a trough 11 is provided and a first terminal hole 12 is configured between the trough 11 and the accommodation space 21. Additionally, there is at least a bolt hole 13 on the body 1 for securing the connection between the connector and cables. To protect the body and the socket pieces 2, and to provide shielding, the body 1 and the socket pieces 2 are housed in a metallic casing 3.

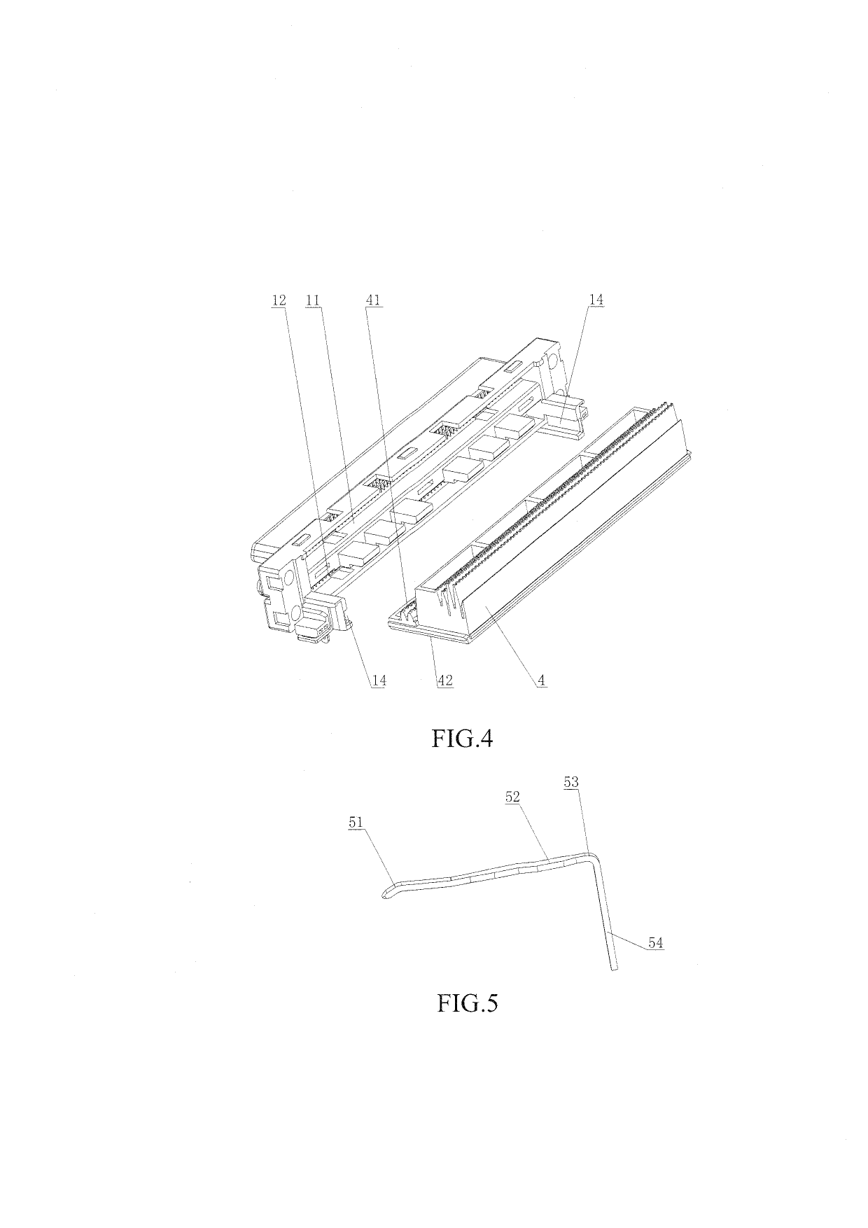

As shown in FIGS. 1 and 4, a terminal positioning seat 4 with a second terminal hole 41 is configured on the back side of the body 1. The terminal positioning seat 4 is configured to have a step-wise shape toward the front direction so that terminals are spaced apart and short circuit is prevented. Along two lateral sides of the terminal positioning seat 4, a fringe 42 is configured, respectively. Correspondingly, the body 1 has two slots 14 to receive the fringes 42. This not only facilitates the assembly of the terminal positioning seat 4 but also, by the guidance of the slots 14, prevents the terminal positioning seat 4 from misalignment.

As shown in FIG. 5, each terminal 5 contains a contact section 51, an installation section 52, a corner section 53, and a soldering section 54. The contact section 51 penetrates the first terminal hole 12 into the accommodation space 21 and one of the terminal slots 22. The soldering section 54 penetrates the second terminal hole 41 into the terminal positioning seat 4. Upon the installation sections 52 of the terminals 5, a terminal installation seat 6 is positioned.

As described, the connector provides two sockets and therefore it is capable of connecting two cables with a single connector, instead of two connectors. The space required is reduced and the cost is lowered. Terminals are securely positioned in the accommodation space 21 to enhance connection reliability The terminal positioning seat 4 on the other hand facilitate the configuration of the terminals and helps positioning the terminals.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A high-density connector, comprising:
an insulating body having at least two socket pieces extended towards a front direction wherein each socket piece contains an accommodation space; an array of terminal slots is configured along a top side and a bottom side of said accommodation space, respectively; and a first terminal hole is configured on said body connecting said accommodation space;
a terminal positioning seat configured on a back side of said body, said terminal positioning seat having a second terminal hole; and
a plurality of terminals, each having one end penetrating though said first terminal hole into one of said terminal slots and the other end penetrating through said second terminal hole into said terminal positioning seat.

2. The high-density connector according to claim 1, wherein, along two lateral sides of said terminal positioning seat, a fringe is configured, respectively; and, for each fringe, a corresponding slot is configured on said body.

3. The high-density connector according to claim 1, wherein a front side of said terminal positioning seat is configured to have a step-wise shape.

4. The high-density connector according to claim 1, wherein at least a bolt holes is configured on said body so as to enhance said connector's connection with cables.

5. The high-density connector according to claim 1, wherein said body and socket pieces are housed in a metallic casing for protection and shielding.

6. The high-density connector according to claim 1, wherein each terminal comprises a contact section, an installation section, a corner section, and a soldering section; said contact section penetrates into said accommodation space; said soldering section penetrates into said terminal positioning seat through second terminal hole; and a terminal installation seat is positioned upon said installation sections of said terminals.
